(19) United States
(12) Patent Application Publication
(10) Pub. No.: US 2017/0144039 A1
(43) Pub. Date: May 25, 2017

(54) SHOE/ACCESSORY HOLDER FOR A GOLF BAG

(71) Applicant: John M. Taylor, Arnold, MO (US)

(72) Inventor: John M. Taylor, Arnold, MO (US)

(21) Appl. No.: 15/012,911

(22) Filed: Feb. 2, 2016

Related U.S. Application Data
(60) Provisional application No. 62/386,140, filed on Nov. 20, 2015.

(51) Int. Cl. A63B 55/00; F16M 13/02

(52) U.S. Cl. CPC A63B 55/408; F16M 13/022

(57) ABSTRACT

A holder (10) for use with a golf bag (B) to conveniently store golf accessories for ready access by a golfer comprises a unitary frame having a first section (12) that fits into the mouth of the bag and extends down inside it. A second frame section includes arms (14, 16) that fit over a mouth of the bag and extend a distance down the outside of the bag. Arm portions of a third frame section extend upwardly and outwardly away from the side of the bag. A golf accessory/accessories are fitted onto outer ends of the arms, these outer ends having a decorative shape. The holder allows a golfer to keep an accessory together with the golf bag for ready access by the golfer.

### CROSS REFERENCE TO RELATED APPLICATIONS

This application is based upon and claims the benefit of Provisional patent applications 62/386,140 filed Nov. 20, 2015, 61/999,976 filed Aug. 12, 2014, and 61/960,086 filed Sep. 10, 2013.

### STATEMENT REGARDING FEDERALLY SPONSORED RESEARCH OR DEVELOPMENT

N/A

### BACKGROUND OF THE INVENTION

This invention relates to storing golf related accessories; and, more particularly, to a golf shoe and other golf accessory holder installed on a golf bag to make easy to llocate the shoes or accessories.

Golfers use many accessories in playing their game. These include, for example, golf shoes, golf gloves, and hats. At the end of a round, or between rounds, the golfer needs to store these someplace convenient. Many golfers will accordingly put them in the trunk of their car, in their basement, or in their garage. The problem comes in being able to readily find these items the next time they get ready to play. Often other things are put in the trunk of the golfer's car between the last time they played and this time; or things put in a basement or garage get moved around. Accordingly, the shoes, gloves, or hats can get easily misplaced causing the golfer to spend time finding them before heading off to the course. Further, while many golf bags have pockets in which a golfer can store their golf balls, ball markers, tees, etc., these provide only provide a limited storage space and therefore the golfer often needs to store their golf accessories elsewhere.

The one item though that usually does not get lost is the golfer's bag. Because of its size, its will be readily located. It would be helpful therefore to have an accessory that is attached to the bag and on which shoes, gloves, or hats can be placed so that when the golfer locates their bag, these other items they need to play golf are there as well and do not need to be otherwise found.

### BRIEF SUMMARY OF THE INVENTION

The present invention is directed to a golf bag accessory which is removably attachable to a golf bag and which makes it easy for a golfer to conveniently store items they use playing golf. These items, in particular, include the golfer's shoes. By using the accessory, a golfer knows exactly where they are and does not need to search for them when he or she gets ready for a round of golf.

The accessory comprises a lightweight metal or plastic holder one end of which is inserted down inside a golf bag. The other end of the accessory is located outside the bag and includes a plurality of upstanding arms that allow the golfer to, for example, insert a golf shoe over the outer end of an arm to hold it in place. Since the holder is attached to the bag, the golfer's shoes will stay with the bag wherever it is stored.

The holder is available in different colors and the outer ends of the arms can be decoratively formed; as, for example, in the shape a head of a golf club as well as other shapes.

The holder is flexible which allows it to be inserted into the mouth of a variety of golf bags such as carry bags and large bags usually placed on a golf cart.

The holder is easily removed and stored when not in use.

Other objects will be in part apparent and in part pointed out hereinafter.

### BRIEF DESCRIPTION OF THE SEVERAL VIEWS OF THE DRAWINGS

The accompanying figures, together with detailed description which follows, form part of the specification and illustrate the various embodiments described in the specification.

FIGS. 1 and 2 are respective side and front elevation views of the holder, with FIG. 1 illustrating the holder installed on a golf bag; and,

FIG. 3 is a top plan view of the holder.

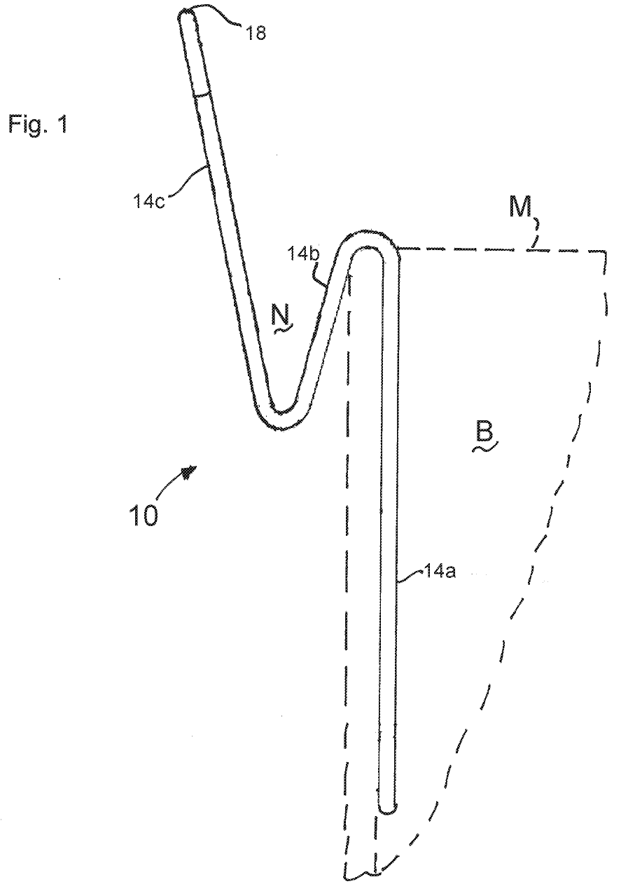

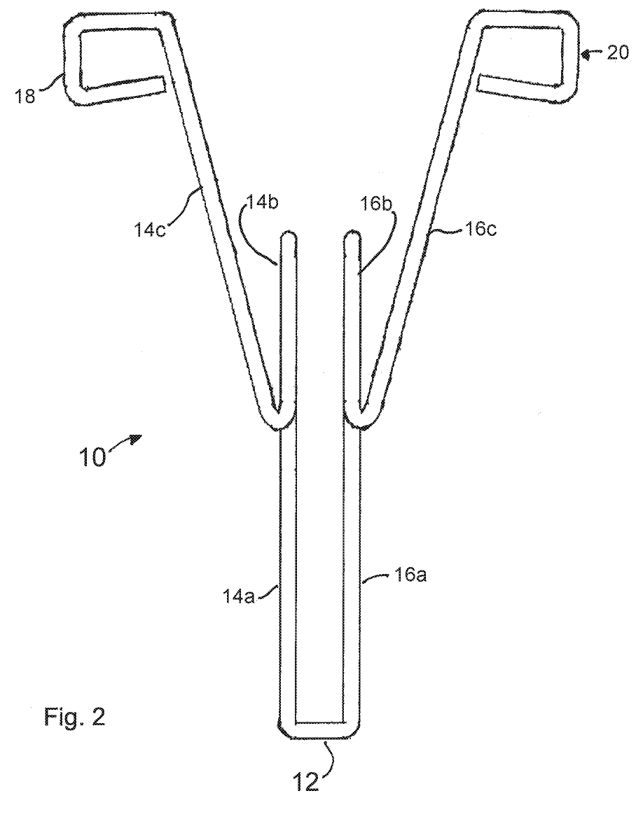

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the drawings, a golf accessory of the present invention comprises a holder 10 which is removably inserted into the mouth M of a golf bag B. Those skilled in the art will understand that while only one holder 10 is shown in the drawings as being inserted into a golf bag, a second holder 10 could also be inserted thereinto. That is, one holder 10 would be located on one side of the bag and another holder on the opposite side. As is described, holder 10 allows a golfer to conveniently store their shoes, hats, golf gloves or other items with their bag.

Holder 10 comprises a frame preferably formed from a single piece of lightweight metal, or it can be molded from a lightweight, yet sturdy plastic material. When viewed in elevation, as shown in FIGS. A and 2, the holder has a generally elongate Vee shape, when oriented vertically, with a straight base section 12, and upwardly and outwardly projecting arms 14, 16. The outer ends 18, 20 of the respective arms are formed into an appropriate, decorative shape. For example, and as shown in the drawings, the respective outer ends 18, 20 are shaped like the head of a golf club. It will be understood that the ends can be other shapes without departing from the scope of the invention.

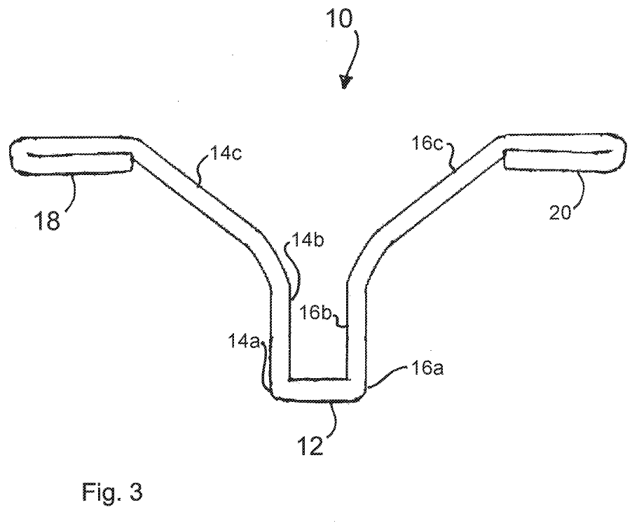

Referring to FIG. 3, each arm 14, 16 of the holder frame has a first section 14a, 16a which extends generally vertically upwardly from base 12 of the first frame section along the inside of the golf bag.

Next, the frame has second arm sections 14b, 16b each of which is of an inverted U-shape. When holder 10 is inserted into golf bag B, the sections 14a, 16a of the frame arms extend a distance down the inside of mouth M of the bag. The arcuate portions of the respective sections 14b, 16b now fit over the mouth of the bag and become straight sections that extend a distance down the outside of the bag before converting into a lower generally U-shaped section outside the bag. The upper U-shaped portion of frame sections 14b, 16b rest against the mouth of the bag so to install holder 10 in place.

Finally, each arm 14, 16 has a third section 14c, 16c. These sections are on the outside of bag B when the holder is in place; and, as shown in the drawings, angle outwardly and upwardly away from the side of the bag. By forming the legs 14, 16 in this way, it makes it easier for a golfer to install items onto the ends of the arms, and subsequently remove them.

It will be understood by those skilled in the art that the angles at which the arms extend away from each other can be greater or lesser than the angle shown in the drawings. The resulting spacing between the outer ends of the arms makes it easier to place bigger, bulkier items such as golf shoes on the ends of the arms without the shoes bumping into each other.

While holder 10 makes it easy for a golfer to place one shoe of each pair of his golf shoes on the arms 14, 16, these arms extending inside a shoe with the inside, toe end of each shoe resting against an outer end 18, 20 of the respective arms, other items can be stored on holder 10 at the same time. For example, a notch N is formed where the curved lower end of arm sections 14c, 16c, merge with the curved lower ends of their adjacent sections 14b, 16b. A golf glove can be lodged and held in this notch, as can be a golf towel. The towel or glove, just as the golf shoes are then conveniently stored so the golfer knows they are with their bag, and does not have to search for them before the next round of golf.

In view of the above, it will be seen that the several objects and advantages of the present disclosure have been achieved and other advantageous results have been obtained.

1. A holder for attachment to a golf bag to conveniently store golf accessories used by a golfer on the holder so the accessories are readily accessible to the golfer when the golfer goes to play golf comprising:
a unitary frame having a generally elongate V shape in a vertical orientation of the frame, the frame further having a first section for insertion into a mouth of the golf bag and for extending a distance down an inside of the golf bag to attach the holder to the golf bag;
a second frame section fitting over the mouth of the bag and extending a distance down an outside of the bag; and,
a third frame section comprising a pair of spaced arms which extend outwardly and upwardly away from the outside of the bag, each of said arms having a generally rectangular shaped, substantially enclosed outer end, each said outer end being perpendicular to an outwardly extending portion of a remainder of a respective arm, each said outer end providing a location on which a golf accessory can be installed on the holder and held in place by the frame so to keep the accessory together with the golf bag and afford ready access to the accessory by the golfer.

2. (canceled)

3. The holder of claim 1 in which the first frame section has a base at the lower end of the first frame section with two spaced arms extending generally upwardly from the base at respective ends of the base.

4. The holder of claim 3 in which each arm forms a portion of the second frame section, each arm having an inverted U-shape formed adjacent an upper end of the first frame section, said inverted U-shape portions of the arms fitting over a top of the bag and resting against the mouth of the bag for insertion of the holder into the bag.

5. The holder of claim 4 wherein each arm of the second frame section further has a generally straight section extending a distance down the outside of the golf bag, adjacent a side of the bag, and with a U-shaped section formed at a lower, outside end of each straight section.

6. The holder of claim 5 wherein the upper ends of the respective arms of the third section are farther apart from each other than the lower ends of the arms where the third section begins, so to make it easier for a golfer to place an accessory onto an ends of an arm, and subsequently remove the accessory therefrom.

7. The holder of claim 5 wherein the second frame section of the arms of the frame form a notch in which an accessory is placed.

8. (canceled)

9. The holder of claim 3 in which the base is a generally straight base.

10. (canceled)
